(19) United States
(12) Patent Application Publication
(10) Pub. No.: US 2021/0370572 A1
(43) Pub. Date: Dec. 2, 2021

(54) METHOD AND APPARATUS FOR MANUFACTURING A BOWDEN CABLE AND BOWDEN CABLE

(71) Applicant: Pressan Madeni Esya San. Tic. A.S., Istanbul (TR)

(72) Inventors: Buelent Bilgincan, Instanbul (TR); Hasan Guersoy, Istanbul (TR)

(21) Appl. No.: 16/632,442

(22) PCT Filed: Jul. 20, 2017
(86) PCT No.: PCT/EP2017/068431

§ 371 Date: Jan. 20, 2020

(51) Int. Cl. B29C 48/155; F16C 1/26; F16C 1/10; E05B 77/36; E05B 79/20; B29C 45/14; B29C 48/06; B29C 48/25; B29C 48/92; B29C 45/76; G10K 11/162

(52) U.S. Cl. CPC B29C 48/155; B29K 2021/003; F16C 1/108; E05B 77/36; E05B 79/20; B29C 45/14565; B29C 48/06; B29C 48/2694; B29C 48/92; B29C 45/76; G10K 11/162; F16C 2326/01; F16C 2220/48; F16C 2208/10; B29C 2948/9258; B29C 2948/92904; B29C 2945/76595; B29C 2945/76732; F16C 1/26

(57) ABSTRACT

The disclosure is directed to a method for manufacturing a Bowden cable, in particular a Bowden cable of a closure element arrangement of a motorized vehicle, comprising the step of applying a noise dampening sleeve to a Bowden cable housing. It is suggested that the noise dampening sleeve is molded onto the Bowden cable housing.

### CROSS-REFERENCE TO RELATED APPLICATIONS

This application is a national stage application under 35 U.S.C. 371 of International Patent Application Serial No. PCT/EP2017/068431, entitled “METHOD AND APPARATUS FOR MANUFACTURING A BOWDEN CABLE AND BOWDEN CABLE,” filed Jul. 20, 2017, the disclosure of which is incorporated herein by reference.

### FIELD OF THE TECHNOLOGY

The disclosure is directed to a method for manufacturing a Bowden cable, an apparatus for manufacturing a Bowden cable with a noise dampening sleeve on a Bowden cable housing, a Bowden cable as well as a closure element arrangement.

### BACKGROUND

Bowden cables in general are well known in the state of the art. They usually comprise an inner cable for transferring a mechanical movement and/or a tensile or compressive force, and a Bowden cable housing circumferentially surrounding the inner cable. Bowden cables are for example used in closure element arrangements of motor vehicles, in particular for opening a vehicle door as closure element. A Bowden cable usually connects a door handle with a motor vehicle lock for transferring an actuation force of the door handle to the motor vehicle lock, example given for opening the motor vehicle lock.

While opening and closing the closure element or while driving the Bowden cable usually starts vibrating and may knock on components of the closure element. This leads to undesired knocking noises. In order to prevent this knocking noises noise dampening sleeves have been developed to be applied to the Bowden cable. One example of such a noise dampening sleeve is described in the German utility model DE 203 01 955 U1.

These noise dampening sleeves are usually pulled over the Bowden cable housing of the Bowden cable or the Bowden cable housing is pushed through the noise dampening sleeve. In both cases the noise dampening sleeve may be widened for example with compressed air. What these methods have in common is that the Bowden cable and the noise dampening sleeve are manufactured separately and afterwards the noise dampening sleeve is applied to the Bowden cable manually.

Pulling the Bowden cable housing over the Bowden cable manually or pushing the Bowden cable through the noise dampening sleeve manually means a considerable effort during production of the Bowden cables.

### SUMMARY

It is an object of the disclosure to improve the known method for manufacturing a Bowden cable and to lower the manufacturing costs.

The above object is achieved for a method according to the disclosure.

An idea underlying the disclosure is to mold the sleeve, such as the noise dampening sleeve, onto the Bowden cable housing. “Molding” means that a flowable material, the sleeve material, is applied to the surface of the Bowden cable housing, thereby forming the sleeve. Molding a sleeve onto the Bowden cable housing is a very simple way to provide a Bowden cable housing with sleeve. On one hand, this method allows to automate the application and thereby reduce manufacturing costs. In particular, the manufacturing process can be a continuous inline production process, whereas the production of a Bowden cable according to the state of the art had always to be interrupted for cutting a Bowden cable housing to length and then applying the separately manufactured noise dampening sleeve to the cut Bowden cable housing piece. On the other hand, the method also enables a better connection between the noise dampening sleeve and the Bowden cable housing. Especially shear forces along the longitudinal axis of the Bowden cable housing on the noise dampening sleeve can much better be resisted. A shifting of the noise dampening sleeve is efficiently prevented.

The noise dampening sleeve may be extruded or injection molded onto the Bowden cable housing.

According to various embodiments, the noise dampening sleeve is molded onto one or more separate house sections of the Bowden cable housing. This allows to apply the noise dampening sleeve only on those areas of the Bowden cable housing, on which a noise dampening sleeve is required. For example the noise dampening sleeve may only be applied to a middle section of the Bowden cable housing, whereas the end sections of the Bowden cable housing remain free. Although molding usually is a continuous process it has been proven that the molding of a noise dampening sleeve onto a Bowden cable housing can be interrupted in sections.

According to various embodiments, at least two sleeve sections of the noise dampening sleeve may be molded onto the Bowden cable housing, which sleeve sections are spaced apart along the longitudinal axis of the noise dampening sleeve, thereby forming a multi-part noise dampening sleeve. In doing so, a noise dampening sleeve may be applied to the Bowden cable housing only in areas, in which it is beneficial.

According to various embodiments, the Bowden cable housing is pulled and/or pushed through a mold for applying the noise dampening sleeve thereon. Additionally or alternatively, the mold may be moved along the Bowden cable housing.

In some embodiments, various features of the method relating to the mold are described which improve the efficiency of the method and/or allow a shaping of the noise dampening sleeve.

Various embodiments include an additional mold for molding an additional noise dampening sleeve onto an additional Bowden cable housing, wherein both molds are fed by the same extruder. Thereby, two Bowden cable housings can be provided with a respective noise dampening sleeve at the same time.

Additionally, the above object is achieved by an apparatus for manufacturing a Bowden cable comprising a Bowden cable housing with a noise dampening sleeve with various features described herein.

The same advantages can be achieved with this apparatus as already described in connection with the before mentioned method.

According to some embodiments the apparatus comprises a mold arrangement with at least two molds for providing two Bowden cable housings with a respective noise dampening sleeve at the same time.

Various features of the apparatus and its corresponding mold or molds are described herein.

Furthermore, the above object is achieved with a Bowden cable according to the disclosure.

The same advantages are achieved as previously described in connection with the method and/or the apparatus.

Various features of the Bowden cable are described herein. In particular, the structure of the inner surface of the noise dampening sleeve is complementary (corresponds) to the structure of the outer surface of the Bowden cable housing.

Finally, the above object is achieved with a closure element arrangement of a motorized vehicle according to the disclosure.

The same advantages are achieved as previously described with the method, the apparatus and/or the Bowden cable.

Various embodiments provide a method for manufacturing a Bowden cable, in particular a Bowden cable of a closure element arrangement of a motorized vehicle, comprising the step of applying a sleeve, such as a noise dampening sleeve, to a Bowden cable housing, wherein the sleeve, such as the noise dampening sleeve, is molded onto the Bowden cable housing.

In various embodiments, the noise dampening sleeve is extruded or injection molded onto the Bowden cable housing.

In various embodiments, the noise dampening sleeve is molded onto at least one housing section of the Bowden cable housing, such that the noise dampening sleeve is molded onto at least one longitudinal housing section of the Bowden cable housing and/or onto at least one circumferential housing section of the Bowden cable housing, further such that the noise dampening sleeve completely surrounds the Bowden cable housing.

In various embodiments, a multi-part noise dampening sleeve is formed by molding at least two sleeve sections of the noise dampening sleeve onto the Bowden cable housing, which are spaced apart along the longitudinal axis of the same.

In various embodiments, during molding of the noise dampening sleeve onto the Bowden cable housing, the Bowden cable housing is pulled and/or pushed through a mold and/or a mold circumferentially surrounding the Bowden cable housing is moved along the Bowden cable housing.

In various embodiments, the pushing and/or pulling of the Bowden cable housing and/or the movement of the mold is controlled by an analog control and/or that the pushing and/or pulling of the Bowden cable housing and/or the movement of the mold is NC-controlled.

In various embodiments, the Bowden cable housing enters the mold through an inlet and exits the mold together with the noise dampening sleeve through an outlet, wherein at least one gap is formed between at least one circumferential part of the inner edge of the outlet and the Bowden cable housing, in particular between the complete inner edge of the outlet and the Bowden cable housing.

In various embodiments, the outlet and/or the gap is closed via a movement, in particular a linear movement, of a closing member of the mold, such that the outlet and/or the gap is closed via a linear movement of a closing member of the mold along the longitudinal axis of the Bowden cable housing or perpendicular to the longitudinal axis of the Bowden cable housing.

In various embodiments, the closing member guides the Bowden cable housing through the mold, such that the closing member comprises a guiding channel through which the Bowden cable housing is guided while passing through the mold.

In various embodiments, the noise dampening sleeve is being shaped by means of a forming element of the mold after the noise dampening sleeve material has been applied onto the Bowden cable housing, such that, by being shaped, the noise dampening sleeve receives a star-shaped, circular-shaped, elliptical-shaped, triangular-shaped, rectangular-shaped or polygonal-shaped cross-section.

In various embodiments, by means of an additional mold an additional noise dampening sleeve is molded onto an additional Bowden cable housing, while both molds are being fed by a shared extruder, wherein, during molding of the additional noise dampening sleeve onto the additional Bowden cable housing, the additional Bowden cable housing is pulled and/or pushed through the additional mold and/or the additional mold circumferentially surrounding the Bowden cable housing is moved along the additional Bowden cable housing.

In various embodiments, the pushing and/or pulling of the Bowden cable housing and/or the movement of the mold is controlled by an analog control and/or that the pushing and/or pulling of the additional Bowden cable housing and/or the movement of the additional mold is NC-controlled.

In various embodiments, the sleeve sections of the noise dampening sleeves are respectively molded onto the related one of the Bowden cable housings in an alternating manner.

Various embodiments provide an apparatus for manufacturing a Bowden cable comprising a Bowden cable housing with a sleeve, such as a noise dampening sleeve, in particular for carrying out the method according to the disclosure, the apparatus comprising: a supplying unit for supplying the Bowden cable housing, a mold through which the Bowden cable housing is feedable and an extruder for providing a sleeve material, such as noise dampening sleeve material, to the mold, wherein the apparatus is configured such that a sleeve, such as a noise dampening sleeve, is moldable onto the Bowden cable housing, such as onto at least one housing section of the Bowden cable housing, by applying the sleeve material, such as the noise dampening sleeve material, onto the Bowden cable housing in the mold.

In various embodiments, the apparatus comprises at least one additional mold, wherein all molds together form a mold arrangement, such that the mold arrangement is configured such that by means of the additional mold an additional noise dampening sleeve is moldable onto an additional Bowden cable housing, while both molds are being fed by a shared extruder, wherein, during molding of the additional noise dampening sleeve onto the additional Bowden cable housing, the additional Bowden cable housing can be pulled and/or pushed through the additional mold and/or the additional mold circumferentially surrounding the Bowden cable housing is movable along the additional Bowden cable housing, further such that the pushing and/or pulling of the additional Bowden cable housing and/or the movement of the additional mold is NC-controlled.

In various embodiments, the mold or each mold comprises an inlet and an outlet, which are configured such that the Bowden cable housing can enter the mold through the inlet and can exit the mold together with the noise dampening sleeve through the outlet, such that at least one gap is formed between at least one circumferential part of the inner edge of the outlet and the Bowden cable housing, in particular between the complete inner edge of the outlet and Bowden cable housing.

In various embodiments, the mold or each mold comprises a closing member for closing the outlet and/or the gap, such that the outlet and/or the gap is closable via a linear movement of the closing member, further such that the outlet and/or the gap is closable via a linear movement of the closing member along the longitudinal axis of the Bowden cable housing or perpendicular to the longitudinal axis of the Bowden cable housing.

In various embodiments, the closing member comprises a guiding channel for guiding the Bowden cable housing during the molding of the noise dampening sleeve onto the Bowden cable housing.

In various embodiments, the mold comprises an actuator for opening and closing the closable gap by moving the closing member.

In various embodiments, at least partly, the closing member and/or a forming element of the mold, which shapes the noise dampening sleeve after its material is applied to the Bowden cable housing, has in cross-section a star-shape, circular-shape, elliptical-shape, triangular-shape, rectangular-shape or polygonal-shape.

In various embodiments, the forming element forms the inner edge of the outlet, such that the closable gap is closable by abutment and/or engagement of the closing member with the forming element.

Various embodiments provide a Bowden cable comprising an inner cable and a Bowden cable housing circumferentially surrounding the inner cable, such that the Bowden cable housing has been manufactured according to a method as described herein and/or by means of an apparatus as described herein, wherein a sleeve, such as a noise dampening sleeve, has been molded onto the Bowden cable housing.

In various embodiments, the structure of the inner surface of the noise dampening sleeve is complementary to the structure of the outer surface of the Bowden cable housing.

In various embodiments, the noise dampening sleeve has been molded onto at least one housing section of the Bowden cable housing, such that the noise dampening sleeve has been molded onto at least one longitudinal housing section of the Bowden cable housing and/or onto at least one circumferential housing section of the Bowden cable housing, further such that the noise dampening sleeve completely surrounds the Bowden cable housing.

Various embodiments provide a closure element arrangement of a motorized vehicle comprising a door handle and a motor vehicle lock, wherein the door handle and the motor vehicle lock are mechanically connected via an actuation chain, which transfers an actuation of the door handle to the motor vehicle lock, wherein a Bowden cable as described herein is integrated into the actuation chain and participates in the transfer of the actuation of the door handle to the motor vehicle lock.

### BRIEF DESCRIPTION OF THE DRAWINGS

In the following various embodiments will be described based on an example with reference to the drawings. In the drawings

FIG. 1 schematically shows an embodiment of an apparatus according to the disclosure for carrying out the method according to the disclosure,

FIG. 2 schematically shows a second embodiment of an apparatus according to the disclosure for carrying out the method according to the disclosure,

FIG. 3 schematically shows an embodiment of a mold arrangement of an apparatus of the disclosure,

FIG. 4 schematically shows in a) a sectional view of the mold arrangement shown in FIG. 3 with an opened mold and in b) with a closed mold and

FIG. 5 schematically shows in a) a partly sectional view of a Bowden cable according to the disclosure and in b) a closure element arrangement of a motorized vehicle comprising the Bowden cable of FIG. 5a).

### DETAILED DESCRIPTION

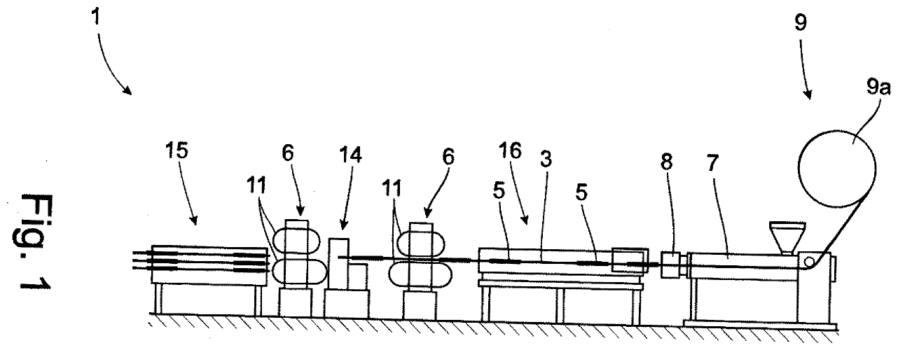

FIG. 1 shows a first embodiment of an apparatus 1 according to the disclosure for carrying out the method of the disclosure and for manufacturing a Bowden cable 2 according to the disclosure.

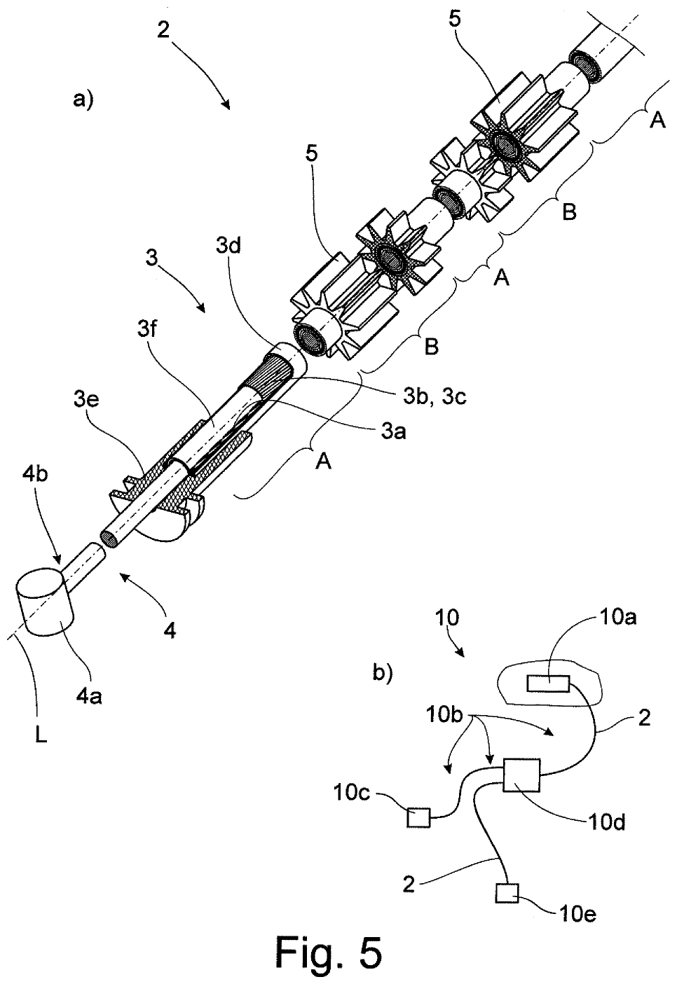

Such a Bowden cable 2 is shown in its assembled state in FIG. 5a). The Bowden cable 2 comprises a Bowden cable housing 3 and an inner cable 4, wherein the Bowden cable housing 3 circumferentially surrounds the inner cable 4. Such a Bowden cable 2 may be used to transmit mechanical movements and forces, particularly push and pull forces.

As can be seen in the embodiment of FIG. 5a), the Bowden cable housing 3 typically comprises a composite construction, which is known from the state of the art. It comprises an inner lining 3a, which may be of Teflon material in order to reduce the friction between the inner cable 4 and the Bowden cable housing 3. Further, the Bowden cable housing 3 may comprise a longitudinally incompressible layer 3b, such like for example a helical winding or a sheaf of steel wire 3c. The Bowden cable housing 3 further comprises a protective outer shell 3d. Here the protective outer shell 3d is a plastic coating. The outer shell material of the Bowden cable housing 3 can comprise PA (Polyamide), can further consist of PA. The outer shell material of the embodiment of FIG. 5a) is in particular compliant to the European Directive 2011/65/EU (RoHS compliant).

In the final assembled state of the Bowden cable 2, the Bowden cable housing 3 usually comprises end caps 3e on its ends 3f With such end caps 3e for example the Bowden cable housing 3 may be mounted to a component or components of a closure element arrangement 10 as is for example shown in FIG. 5b).

The inner cable 4 may comprise connection elements 4a on both of its ends 4b. The connection elements 4a may be formed as a ball or barrel nipple. Such a connection element 4a can be soldered to the ends 4b of the inner cable 4 as such.

A basic idea of the disclosure is to mold, such as to extrude or to injection mold, a sleeve, such as a noise dampening sleeve 5, onto the Bowden cable housing 3. The noise dampening sleeve 5 is also shown in FIG. 5a). It is here of star-shape in a cross-section perpendicular to the Bowden cable housing's 3 longitudinal axis L.

Such a noise dampening sleeve 5 reduces respectively prevents the knocking sounds generated by the Bowden cable 2 impacting a surface, e. g. of a closure element. The knocking sound generation can be reduced respectively prevented by absorbing the impact energy of the Bowden cable by means of the noise dampening sleeve 5. Therefore the noise dampening sleeve 5 may be elastically deformable.

According to various embodiments, the structure of the inner surface of the noise dampening sleeve 5 is complementary to the structure of the outer surface of the Bowden cable housing 3. In contrast thereto, noise dampening sleeves manufactured according to the state of the art have an inner surface which differs from that of a noise dampening sleeve 5 manufactured according to the present disclosure. In particular, in case the noise dampening sleeve 5 is molded onto the Bowden cable housing 3, the inner surface of the noise dampening sleeve 5 will adapt to the outer surface of the Bowden cable housing 3, since it is applied in a flowable condition. If a noise dampening sleeve was produced, respectively molded, separately, the inner surface of such a noise dampening sleeve of the state of the art will correspondent to the mold on which it has been produced and not to the surface of the Bowden cable housing. Since these separately produced noise dampening sleeves of the state of the art are usually molded continuously with a metal mold, the structure of the inner surface of such a separately molded noise dampening sleeve of the state of the art will be more homogeneously in the longitudinal direction than the structure of the inner surface of a noise dampening sleeve 5 of the disclosure.

The noise dampening sleeve 5 may comprise TPE (thermoplastic elastomers TPE), here the noise dampening sleeve consists of TPE, which is molded onto the Bowden cable housing 3. It may be compliant to the European Directive 2011/65/EU (RoHS compliant). TPE provides good dampening characteristics.

In various embodiments, while being molded onto the Bowden cable housing 3 the temperature of the material of the noise dampening sleeve 5 is lower than the melting temperature of the material of the outer shell of the Bowden cable housing 3.

Additionally or alternatively, depending on the temperature during molding, the material of the noise dampening sleeve 5 may build up an adhesive connection with the material of the outer shell 3d of the Bowden cable housing 3.

In various embodiments, the noise dampening sleeve 5 is molded onto at least one housing section of the Bowden cable housing 3, which means that after the molding process the Bowden cable housing 3 comprises one or more housing sections A which do not comprise a noise dampening sleeve.

The Bowden cable housing 3 of the Bowden cable 2 shown in FIG. 5a) comprises one or more sleeve sections B, here for example two sleeve sections B, forming the noise dampening sleeve 5, which sleeve sections B are spaced apart along the longitudinal axis L of the Bowden cable housing 3, thereby forming a multi-part noise dampening sleeve. According to the disclosure, said sleeve sections B are molded onto the Bowden cable housing 3. Additionally, further sleeve sections B may be molded onto the Bowden cable housing 3.

Here the ends 3f of the Bowden cable housing 3 are free from a noise dampening sleeve material. This allows on the one hand installation of the end caps 3e on the Bowden cable housing 3, but also the arrangement of additional noise dampening sleeves of different design, especially of greater radial dimension and/or less longitudinal dimension than the noise dampening sleeve 5 of the disclosure. Additionally or alternatively, these additional noise dampening sleeves may be capable to hold parallel guided electric wires or a second Bowden cable 2.

The noise dampening sleeve 5 and/or the sleeve sections B of the noise dampening sleeve 5 can be elastically deformable. Moreover, they may be of different material.

It may further be noted, that although the inner cable 4 may be inserted into the Bowden cable housing 3 before molding the noise dampening sleeve 5 thereon, it can be, that the inner cable 4 is inserted into the Bowden cable housing 3 after molding the noise dampening sleeve 5 thereon. This allows an easier cutting of the Bowden cable housing 3.

Before or after insertion of the inner cable 4 into the Bowden cable housing 3, the end caps 3e of the Bowden cable 2 may be fitted onto the Bowden cable housing ends 3f After the insertion of the inner cable 4 into the Bowden cable housing 3 the connection elements can then be fitted on the ends 4b of the inner cable 4.

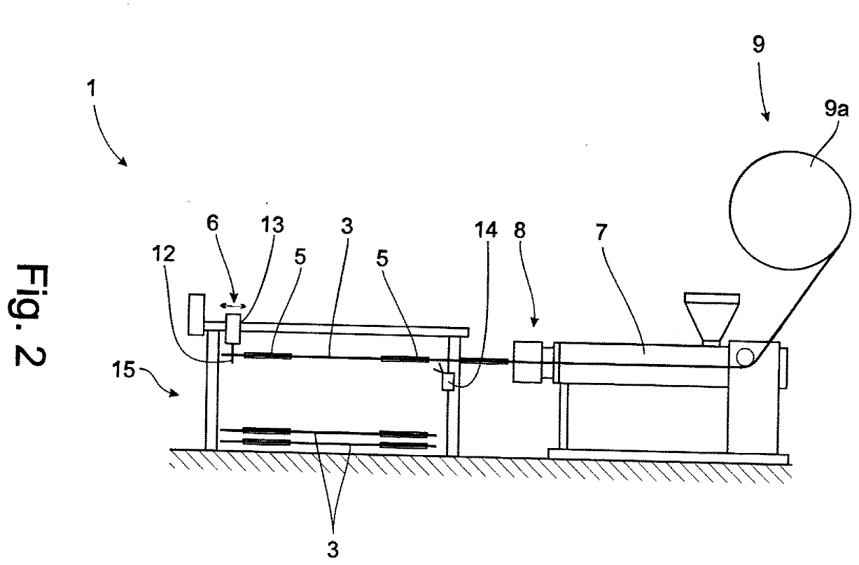

The Bowden cable housings 3 and the respective Bowden cables 2 of the disclosure may be manufactured by means of an apparatus 1 shown in FIG. 1 or by means of an apparatus 1 shown in FIG. 2.

According to various embodiments, an apparatus 1 for manufacturing a Bowden cable 2 comprising a Bowden cable housing 3 with a noise dampening sleeve 5 may comprise a supplying unit 6, an extruder 7 for providing the noise dampening sleeve material to a mold 8 and the mold 8 through which the Bowden cable housing 3 is feedable. With said apparatus the noise dampening sleeve 5 is easily moldable onto the Bowden cable housing 3, such as onto at least one housing section of the Bowden cable housing 3.

Here the apparatus 1 comprises an unwinding unit 9. On the unwinding unit 9 a reel 9a with an endless Bowden cable housing 3 is mounted. By unwinding the Bowden cable housing 3 it can be supplied to the mold 8. Here a supplying unit 6 unwinds the Bowden cable housing 3 and supplies it to the mold 8.

The supplying unit 6 can be installed downstream behind the mold 8. It can pull the Bowden cable housing 3 through the mold 8. In the embodiment of FIG. 1 the supplying unit 6 comprises two driven belts 11 for pulling the Bowden cable housing 3. This may also be done, such as directly, by driven rollers. In the embodiment of FIG. 2 a gripper 12 is provided, which grips the Bowden cable housing 3 and pulls it through the mold 8. The gripper 12 is here driven by a linear drive unit 13 which moves the gripper 12 linearly, such as parallel to the longitudinal extension of the part of the Bowden cable housing 3 placed in the mold 8. It is also conceivable that, in an alternative embodiment, the mold 8 circumferentially surrounding the Bowden cable housing 3 is moved along the Bowden cable housing 3 (not shown).

The supplying of the Bowden cable housing 3, especially the pulling and/or pushing, is here NC-controlled. It may also be controlled by an analog control. In further embodiments one or more additional supplying units 6 may be provided, as it is the case in the embodiment of FIG. 1.

The apparatus 1 may additionally comprise a cutter 14 for cutting the endless Bowden cable housing 3 into sections. Here the cutter 14 is arranged after the extruder 7 and/or before the supplying unit 6. Behind the cutter 14, a storage 15 for the Bowden cable housings 3 may be provided. The storage 15 can especially be designed as a dumping shut.

Moreover, the apparatus 1 of the embodiment of FIG. 1 additionally comprises a cooling unit 16 between the supplying unit 6 and the extruder 7. This cooling unit 16 is designed as a tunnel through which the Bowden cable housing 3 with the molded noise dampening sleeve 5 is fed, here before cutting the endless Bowden cable housing 3 to length.

The apparatus 1 may further comprise a control unit (not shown) for controlling the apparatus 1. The control unit may be an analog control. In the embodiments, the control unit may comprise a NC controller for controlling the supplying unit 6. Additionally, the control unit can also control the unwinding unit 9, the extruder 7 and/or the cutter 14.

In the embodiments of FIGS. 1 and 2 the apparatus 1 further comprises a mold arrangement 18. The mold 8 is part of this mold arrangement 18. The Bowden cable housing 3 enters the mold 8 through an inlet 19a, which is here part of a closing member 20 which will be described later on. The mold arrangement 18 also comprises an outlet 19b through which the Bowden cable housing 3 exits the mold 8 together with the applied noise dampening sleeve material. In so far the outlet 19b also serves for dispensing the noise dampening sleeve material out of the mold arrangement 18. The outlet 19b may also be used to reduce the pressure within the mold arrangement 18 and/or the extruder 7, when no noise dampening sleeve material is applied on the Bowden cable housing 3. In various embodiments, the closing of the outlet 19b via the closing member 20 is controlled by the control unit.

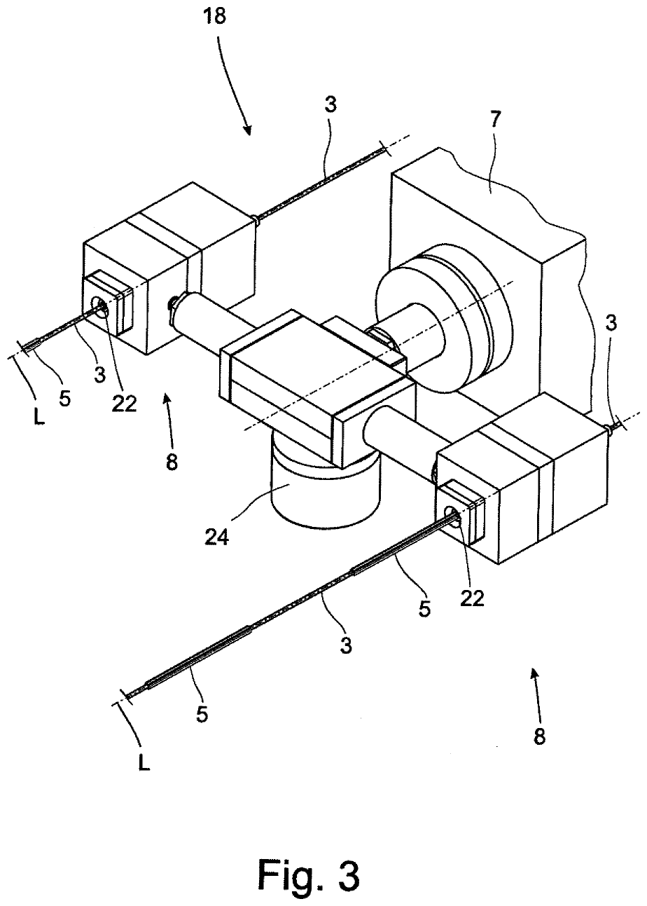

In various embodiments, the mold arrangement 18 comprises at least on additional mold 8, what is shown in FIG. 3. In various embodiments, the additional mold 8 comprises the same features as the first mold 8 described above. The additional mold 8 may be designed symmetrically, especially axially symmetrically and/or plane symmetrically, to the first mold 8.

The mold 8 or the molds 8 shall be described in more detail below. As shown in FIG. 3 the Bowden cable housing 3 is feedable through the mold 8. It is fed as described before by the supplying unit 6.

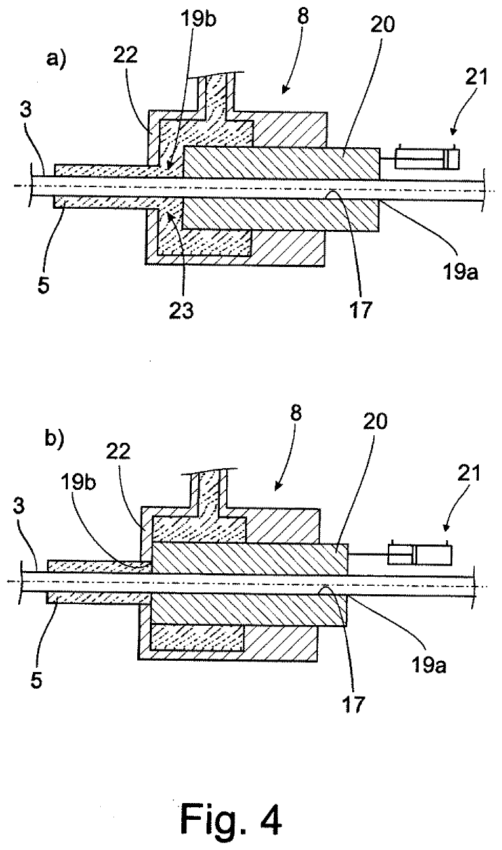

The mold 8 is configured for molding the noise dampening sleeve 5 circumferentially around the Bowden cable housing 3. Here, for closing the outlet 19b the mold 8 comprises a closing member 20. The closing member 20 is here movable relative to the mold 8 and/or to the Bowden cable housing 3, in particular linearly. In the embodiment shown in FIGS. 4a) and b) the housing of the mold 8 provides a guidance for the closing member 20.

The closing member 20 forms a movable part of the mold 8, which also guides the Bowden cable housing 3 during the molding of the noise dampening sleeve 5 onto the Bowden cable housing 3. For guiding the Bowden cable housing 3 the closing member 20 may comprise a guiding channel, in particular a circumferentially closed guiding channel (tunnel or bore).

In various embodiments, the outlet 19b is closable via a linear movement of the closing member 20. The linear movement can be along the longitudinal axis of the Bowden cable housing 3 or perpendicular to the longitudinal axis of the Bowden cable housing 3.

For opening and closing the outlet 19b the mold 8 or mold arrangement 18 comprises an actuator 21, in particular a cylinder and piston arrangement. The opening and closing of the outlet 19b is done by the actuator 21 by actuating the closing member 20. The opening and closing of the outlet 19b may be controlled by the control unit. Here the control unit controls the opening and closing by controlling the actuator 21.

In various embodiments, the supplying of the Bowden cable housing 3 is synchronized to the opening and/or closing operation of the outlet 19b. The closing speed with which the outlet 19b is closed, here the speed of the movement of the closing member 20, deviates less than 20%, such as less than 10%, such as less than 5%, from the supplying speed of the Bowden cable housing 3 during closure of the outlet 19b. This allows a very smooth end of the noise dampening sleeve 5 at the end of a section of the Bowden cable housing 3.

Additionally or alternatively, the mold 8 may comprise a forming element 22 for providing the noise dampening sleeve 5 with a predefined outer contour. The forming element 22 shapes the damping sleeve material, such as after it has been applied to the Bowden cable housing 3. Here the forming element 22 shapes the noise dampening sleeve 5 in a cross-section perpendicular to the longitudinal axis L of the Bowden cable housing 3 into a star-shape. Alternatively, the noise dampening sleeve 5 may be shaped into a circular-shape, elliptically-shape, triangular-shape, rectangular-shape or polygonal-shape.

Additionally or alternatively to the noise dampening function the sleeve 5 may serve as a spacer and/or as an anti-twist device for the Bowden cable 2. The features described in conjunction with the noise dampening sleeve may also be applied to a sleeve 5 serving as a spacer and/or anti-twist device.

In the embodiments of FIGS. 4a) and b) a gap 23 is formed between the forming element 22 and the closing member 20, in particular between an axial inner side of the forming element 22 and an axial inner side of the closing member 20. The gap 23 is closed by actuation of the closing member 20 towards the forming element 22. With abutment and/or engagement of the closing member 20 with the forming element 22, the gap 23 and thereby the outlet 19b is, such as completely, closed.

FIG. 5b) finally discloses a closure element arrangement 10 of a motorized vehicle (not shown). Such a closure element arrangement 10 usually comprises a closure element like a vehicle door or a liftgate as well as a door handle 10a and a motor vehicle lock 10b, wherein the door handle 10a and the motor vehicle lock 10b are mechanically connected via an actuation chain 10d, which transfers an actuation of the door handle 10a to the motor vehicle lock 10b. In the particular embodiment a Bowden cable 2 of the type described before is integrated into the actuation chain 10d and participates in the transfer of the actuation of the door handle 10a to the motor vehicle lock 10b. It may also be conceivable that two of such Bowden cables 2 are participating in the transfer of the actuation. In an embodiment the closure element arrangement 10 also comprises a coupling unit 10e to additionally transfer an actuation of the door handle 10a to a separate door brake 10c. This actuation may also be transferred by a Bowden cable 2 of the disclosure.

1. A method for manufacturing a Bowden cable of a closure element arrangement of a motorized vehicle, comprising:
applying a noise dampening sleeve to a Bowden cable housing,
wherein the noise dampening sleeve is molded onto the Bowden cable housing.

2. The method according to claim 1 wherein the noise dampening sleeve is extruded or injection molded onto the Bowden cable housing.

3. The method according to claim 1, wherein the noise dampening sleeve is molded onto at least one housing section of the Bowden cable housing, wherein the noise dampening sleeve is molded onto at least one longitudinal housing section of the Bowden cable housing and/or onto at least one circumferential housing section of the Bowden cable housing, such that the noise dampening sleeve completely surrounds the Bowden cable housing.

4. The method according to claim 1, wherein a multi-part noise dampening sleeve is formed by molding at least two sleeve sections of the noise dampening sleeve onto the Bowden cable housing, which are spaced apart along a longitudinal axis of the same.

5. The method according to claim 1, wherein, during molding of the noise dampening sleeve onto the Bowden cable housing, the Bowden cable housing is pulled and/or pushed through a mold and/or a mold circumferentially surrounding the Bowden cable housing is moved along the Bowden cable housing.

6. The method according to claim 5, wherein the pushing and/or pulling of the Bowden cable housing and/or the movement of the mold is controlled by an analog control and/or that the pushing and/or pulling of the Bowden cable housing and/or the movement of the mold is NC-controlled.

7. The method according to claim 5, wherein the Bowden cable housing enters the mold through an inlet and exits the mold together with the noise dampening sleeve through an outlet, wherein at least one gap is formed between at least one circumferential part of the inner edge of the outlet and the Bowden cable housing, in particular between the complete inner edge of the outlet and the Bowden cable housing.

8. The method according to claim 1, wherein the outlet and/or the gap is closed via a movement, in particular a linear movement, of a closing member of the mold, wherein the outlet and/or the gap is closed via a linear movement of a closing member of the mold along the longitudinal axis of the Bowden cable housing or perpendicular to a longitudinal axis of the Bowden cable housing.

9. The method according to claim 8, wherein the closing member guides the Bowden cable housing through the mold wherein the closing member comprises a guiding channel through which the Bowden cable housing is guided while passing through the mold.

10. The method according to claim 1, wherein the noise dampening sleeve is being shaped by a forming element of the mold after the noise dampening sleeve material has been applied onto the Bowden cable housing, wherein that, by being shaped, the noise dampening sleeve receives a star-shaped, circular-shaped, elliptical-shaped, triangular-shaped, rectangular-shaped or polygonal-shaped cross-section.

11. The method according to claim 1, wherein by an additional mold an additional noise dampening sleeve is molded onto an additional Bowden cable housing, while both molds are being fed by a shared extruder, wherein, during molding of the additional noise dampening sleeve onto the additional Bowden cable housing, the additional Bowden cable housing is pulled and/or pushed through the additional mold and/or the additional mold circumferentially surrounding the Bowden cable housing is moved along the additional Bowden cable housing.

12. The method according to claim 11, wherein the pushing and/or pulling of the Bowden cable housing and/or the movement of the mold is controlled by an analog control and/or that the pushing and/or pulling of the additional Bowden cable housing and/or the movement of the additional mold is NC-controlled.

13. The method according to claim 3, wherein the sleeve sections of the noise dampening sleeves are respectively molded onto the related one of the Bowden cable housings in an alternating manner.

14. An apparatus for manufacturing a Bowden cable comprising a Bowden cable housing with a noise dampening sleeve, the apparatus comprising:
a supplying unit for supplying the Bowden cable housing,
a mold through which the Bowden cable housing is feedable and
an extruder for providing a noise dampening sleeve material, to the mold,
wherein the apparatus is configured such that a noise dampening sleeve, is moldable onto the Bowden cable housing, onto at least one housing section of the Bowden cable housing, by applying the noise dampening sleeve material onto the Bowden cable housing in the mold.

15. The apparatus according to claim 14, wherein the apparatus comprises at least one additional mold, wherein all molds together form a mold arrangement, wherein the mold arrangement is configured such that by the additional mold an additional noise dampening sleeve is moldable onto an additional Bowden cable housing, while both molds are being fed by a shared extruder, wherein, during molding of the additional noise dampening sleeve onto the additional Bowden cable housing, the additional Bowden cable housing can be pulled and/or pushed through the additional mold and/or the additional mold circumferentially surrounding the Bowden cable housing is movable along the additional Bowden cable housing, further wherein the pushing and/or pulling of the additional Bowden cable housing and/or the movement of the additional mold is NC-controlled.

16. The apparatus according to claim 14, wherein the mold or each mold comprises an inlet and an outlet, which are configured such that the Bowden cable housing can enter the mold through the inlet and can exit the mold together with the noise dampening sleeve through the outlet, wherein at least one gap is formed between at least one circumferential part of the inner edge of the outlet and the Bowden cable housing, in particular between the complete inner edge of the outlet and Bowden cable housing.

17. The apparatus according to claim 14, wherein the mold or each mold comprises a closing member for closing the outlet and/or the gap, wherein the outlet and/or the gap is closable via a linear movement of the closing member, further wherein the outlet and/or the gap is closable via a linear movement of the closing member along a longitudinal axis of the Bowden cable housing or perpendicular to the longitudinal axis of the Bowden cable housing.

18. The apparatus according to claim 14, wherein the closing member comprises a guiding channel for guiding the Bowden cable housing during the molding of the noise dampening sleeve onto the Bowden cable housing.

19. The apparatus according to claim 14, wherein the mold comprises an actuator for opening and closing the closable gap by moving the closing member.

20. The apparatus according to claim 14, wherein, at least partly, the closing member and/or a forming element of the mold, which shapes the noise dampening sleeve after its material is applied to the Bowden cable housing, has in cross-section a star-shape, circular-shape, elliptical-shape, triangular-shape, rectangular-shape or polygonal-shape.

21. The apparatus according to claim 14, wherein the forming element forms the inner edge of the outlet, wherein the closable gap is closable by abutment and/or engagement of the closing member with the forming element.

22. A Bowden cable comprising an inner cable and a Bowden cable housing circumferentially surrounding the inner cable, wherein the Bowden cable housing has been manufactured according to a method of claim 1, wherein
a noise dampening sleeve has been molded onto the Bowden cable housing.

23. The Bowden cable according to claim 22, wherein the structure of the inner surface of the noise dampening sleeve is complementary to the structure of the outer surface of the Bowden cable housing.

24. The Bowden cable according to claim 22,
wherein the noise dampening sleeve has been molded onto at least one housing section of the Bowden cable housing wherein the noise dampening sleeve has been molded onto at least one longitudinal housing section of the Bowden cable housing and/or onto at least one circumferential housing section of the Bowden cable housing such that the noise dampening sleeve completely surrounds the Bowden cable housing.

25. A closure element arrangement of a motorized vehicle comprising a door handle and a motor vehicle lock, wherein the door handle and the motor vehicle lock are mechanically connected via an actuation chain, which transfers an actuation of the door handle,
wherein
a Bowden cable according to claim 22 is integrated into the actuation chain and participates in the transfer of the actuation of the door handle to the motor vehicle lock.
